(19) United States
(12) Patent Application Publication
(10) Pub. No.: US 2009/0158041 A1
(43) Pub. Date: Jun. 18, 2009

(54) METHODS AND DEVICES FOR CREATING SECURITY GROUP AND AUTHENTICATION OVER P2P NETWORK

(75) Inventors: Shin Yuk Kang, Daejeon (KR); Ho Jin Park, Daejeon (KR); Kwang Roh Park, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUDE, Daejeon (KR)

(21) Appl. No.: 12/186,803

(22) Filed: Aug. 6, 2008

(30) Foreign Application Priority Data
Dec. 12, 2007 (KR) 10-2007-0128644

(51) Int. Cl. H04L 9/30

(52) U.S. Cl. 713/171

(57) ABSTRACT

A method of creating a security group over a Peer-To-Peer (P2P) network is disclosed. An invitee terminal attaches a public key to a peer advertisement in which its own identification information is encrypted using its own private key, and then sends a resulting peer advertisement over the P2P network. An inviter terminal, which has found the peer advertisement, encrypts a group advertisement, including group information about the security group, using public keys of the corresponding invitee terminal, and then sends a resulting group advertisement to the invitee terminal desired to be invited to the security group. The invitee terminal decrypts the group advertisement using its own private key, and participates in the security group using the group information.

### CROSS-REFERENCE(S) TO RELATED APPLICATIONS

The present invention claims priority of Korean Patent Application No. 10-2007-0128644, filed on Dec. 12, 2007, which is incorporated herein by reference.

### FIELD OF THE INVENTION

The present invention relates to a security group over a Peer-To-Peer (P2P) network, and, in particular, to a method and device for creating a security group over a P2P network in which only specific terminals can participate so as to share content or data over the P2P network, and a method and device for authenticating specific terminals that are allowed to participate in the corresponding security group.

This work was supported by the IT R&D program of MIC/IITA. [2006-S-068-02, Development of Virtual Home Platform based on Peer-to-Peer Networking]

### BACKGROUND OF THE INVENTION

As is well known, a virtual group is created over a P2P network so as to share content or data, and one or more terminals which participate in the group share the content or data.

Further, in the case in which content or data to be shared is important data which requires security, there is a need to create a security group so that only one or more terminals allowed to participate therein can participate in the corresponding group.

Therefore, with regard to the creation of a security group over a P2P network, a technique for forming a security group, the security of which is ensured, and allowing only one or more authenticated terminals to participate in the security group is very important.

However, according to the conventional art, there is a problem in that it is difficult to provide a security group and then provide authentication therefor due to the characteristics of a P2P network.

### SUMMARY OF THE INVENTION

It is, therefore, an object of the present invention to enable an inviter terminal to create a secure security group, and enable only one or more authenticated particular terminals to participate in the security group, so that secure communication can be performed between the inviter terminal and the invitee terminals within the security group.

In accordance with a preferred embodiment of the present invention, there is provided a method of creating a security group over a Peer-To-Peer (P2P) network, including:

one or more invitee terminals each attaching a public key to a peer advertisement in which its own identification information is encrypted using its own private key, and sending a resulting peer advertisement over the P2P network; an inviter terminal, which has found the peer advertisement, encrypting a group advertisement, including group information about the security group, using public keys of the corresponding invitee terminals, and then sending resulting group advertisements to the invitee terminals which the inviter terminal desires to invite to the security group; and each of the invitee terminals which received the group advertisements decrypting the received group advertisement using its own private key, and participating in the security group using the group information.

In accordance with another preferred embodiment of the present invention, there is provided A device for creating a security group over a P2P network, including: one or more invitee terminals each for attaching a public key to a peer advertisement, in which its own identification information is encrypted using its own private key, sending a resulting peer advertisement over the P2P network, and, when a group advertisement including group information about the security group is sent over the P2P network, decrypting the group advertisement using its own private key and participating in the security group using the group information; and an inviter terminal for searching for the peer advertisement to be sent over the P2P network, encrypting the group advertisement using respective public keys of the corresponding invitee terminals, and sending resulting group advertisements to the invitee terminals which the inviter terminal desires to invite to the security group.

In accordance with still another preferred embodiment of the present invention, there is provided A method of an inviter terminal of a security group authenticating one or more invitee terminals over a P2P network, including: the invitee terminals each encrypting a propagation permission request message, together with its own signature, using a public key of the inviter terminal, and sending a resulting propagation permission request message, so as to propagate a message within the security group; the inviter terminal decrypting the propagation permission request message using its own private key, and then authenticating whether the invitee terminal corresponds to a terminal that the inviter terminal has invited; and when the authentication is completed, the inviter terminal sending a propagation permission response message to the corresponding invitee terminal.

In accordance with still another preferred embodiment of the present invention, there is provided a device for authenticating participation in a security group over a P2P network to which a group advertisement, including group information about the security group and a public key of an inviter party, is sent, the device including: one or more invitee terminals each for encrypting a propagation permission request message, together with its own signature, using the public key, and sending a resulting propagation permission request message so as to propagate a message within the security group; and an inviter terminal for decrypting the propagation permission request message using its own private key, authenticating whether the invitee terminal corresponds to a terminal invited by the inviter terminal, and, when the authentication is completed, sending a propagation permission response message to the corresponding invitee terminal.

According to the present invention, an inviter terminal generates a security group, the security of which is ensured, over a P2P network, and only authenticated invitee terminals are allowed to participate in the security group, so that secure communication can be performed between the inviter terminal and invitee terminals within the security group. That is, there is an advantage of creating a security group over the P2P network, and enabling secure communication and service to be provided between desired peers.

### BRIEF DESCRIPTION OF THE DRAWINGS

The above and other objects and features of the present invention will become apparent from the following description of preferred embodiments given in conjunction with the accompanying drawings, in which:

FIG. 1 is a view showing the configuration of a device for creating a security group and authenticating over a P2P network, which can perform a method of creating the security group and authenticating over the P2P network according to the present invention; and

FIG. 2 is a flow chart showing the method of creating the security group and authenticating over the P2P network according to the present invention.

### DETAILED DESCRIPTION OF THE PREFERRED EMBODIMENTS

Hereinafter, preferred embodiments of the present invention will be described in detail with reference to the accompanying drawings. Further, it should be noted that, in the following description, where it is determined that the detailed descriptions of well-known constructions or functions related to the present invention would obscure the gist of the present invention, they are omitted.

In the present invention, one or more terminals, included in a P2P network, propagate respective messages signed with their own private keys, together with public keys, over the network so as to propagate their information over the network. When the messages are received and decrypted using corresponding public keys, information about respective peers can be known. A specific terminal (an inviter party), which desires to create a group, encrypts a group invitation message using the public keys of the respective terminals, and then sends the group invitation message to terminals (invitee parties), which are selected to be allowed to participate in the corresponding group. Since the sent invitation message is encrypted using the public keys of the respective terminals, an arbitrary terminal (a wiretapper) cannot decrypt the invitation message. Since the terminals allowed to participate in the corresponding group can decrypt the invitation message, they can participate in the group. Each of the terminals (invitee parties), which participates in the group, sends a propagation permission request message, signed with its own private key, to the terminal (the inviter party), which has sent the invitation message, so as to propagate a message in the group. When the inviter party receives the propagation permission request message sent by the invitee party, the inviter party determines whether the invitee party corresponds to an invitee party invited by the invitee party based on a list, determines whether the invitee party is a corresponding terminal by performing verification using a public key, and then sends a response message. When the above process is completed, the invitee terminal is allowed to propagate a message and to share data within the group.

### Embodiment

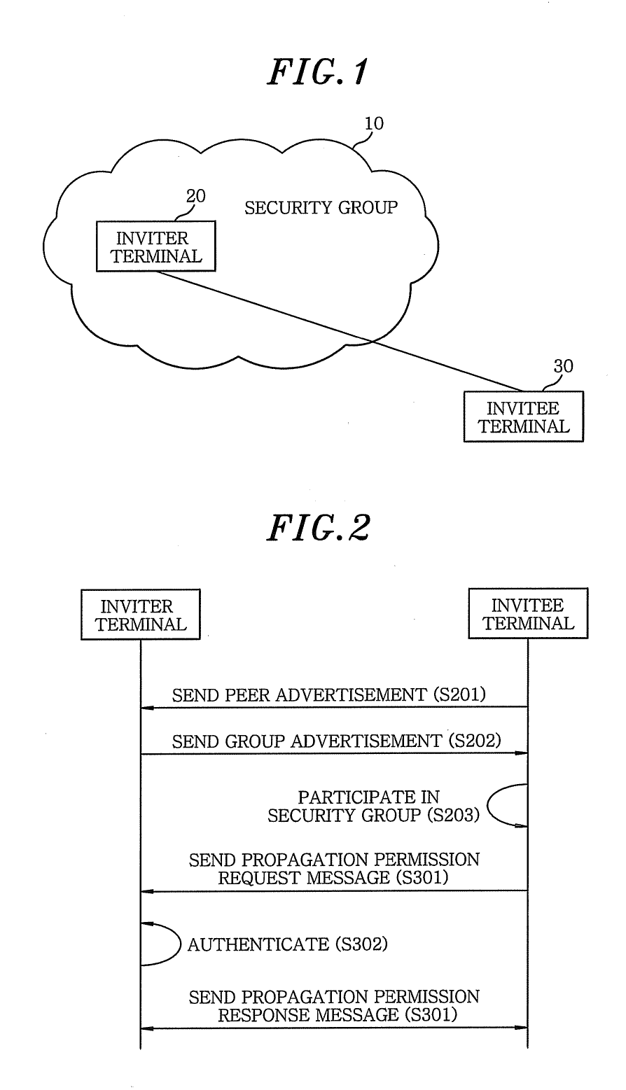

FIG. 1 is a view showing the configuration of a device for creating a security group and authenticating over a P2P network which can perform a method of creating and authenticating the security group over the P2P network according to the present invention.

In FIG. 1, reference numeral 10 indicates a virtual security group created over the P2P network according to the present invention, reference numeral 20 indicates an inviter terminal 20 for creating the security group 10, and reference numeral 30 indicates an invitee terminal 30 invited to the security group 10.

When the inviter terminal 20 desires to create the security group 10, which is initiated by a group advertisement, the inviter terminal 20 sends a security group invitation message to one or more invitee terminals 30 which desire to participate. The invitee terminals 30 that are allowed to participate in the security group 10, that is, the invitee terminals 30 that have received the security group invitation message from the inviter terminal 20, can participate in the virtual security group 10 and share content or data within the security group 10.

FIG. 2 is a flow chart showing the method of creating the security group and authenticating over the P2P network according to the present invention.

Referring to FIG. 2, a method of creating a security group according to the present invention includes an invitee terminal 30 attaching a public key to a peer advertisement in which identification information of the invitee terminal 30 is encrypted using its own private key, and sending the resulting peer advertisement over a P2P network (step S201), an inviter terminal 20, which has found the peer advertisement, encrypting a group advertisement, including group information about a security group, using the public key of the corresponding invitee terminal 30, and then sending the resulting group advertisement to the invitee terminal 30 that the inviter terminal 20 desires to invite to the security group 10 (step S202), and the invitee terminal 30 decrypting the group advertisement using its own private key, and participating in the security group 10 using the group information (step S203). At step S202, the inviter terminal 20 includes its own public key and signature in the group advertisement, and then transmits the resulting group advertisement.

Further, referring to FIG. 2, a method of authenticating the invitee party of the security group according to the present invention includes the invitee terminal 30 encrypting a propagation permission request message, together with its signature, using the public key of the inviter terminal 20 so as to request propagation-permission, and sending the resulting propagation permission request message (step S301), the inviter terminal 20 decrypting the propagation permission request message using its own private key, and then authenticating whether the invitee terminal 30 corresponds to a terminal that the inviter terminal has invited (step S302), and, when the authentication is completed, the inviter terminal 20 sending a propagation permission response message to the corresponding invitee terminal 30 (step S303).

Although, in the present embodiment, a process of creating a security group and a process of authenticating a invitee party of the security group are described using a single flow chart, as shown in FIG. 2, it is apparent that the creation of a security group and the authentication of a invitee party of the security group can be separately performed on security groups which are different from each other.

The process of creating a security group and authenticating according to the present invention, which is constructed as described above, will be described in detail with reference to FIGS. 1 and 2.

The method of creating a security group and authenticating according to an embodiment of the present invention starts from the invitee terminal 30. Before a group is created, all peers sign their own information using their own private keys, and then propagate the resulting information, together with public keys, over the P2P network (step S201).

The inviter terminal 20 selects one or more peers desired to be participated in the security group 10 from among the found plurality of peers. Thereafter, the inviter terminal 20 encrypts a group advertisement, including information about the security group 10, using the public keys of the respective invitee terminals 30, and then sends the resulting group advertisement to the selected peers (step S202). Here, the public key of the inviter terminal 20 is included in the group advertisement, together with the signature of the inviter terminal 20.

When the invitee terminals 30 receive the group advertisement, each of the invitee terminals 30 decrypts the group advertisement using its own private key, so that the invitee terminal 30 can know the information about the security group 10 and participate in the security group 10 using the group information included in the group advertisement (step S203).

Thereafter, in order to propagate a message within the security group 10, the invitee terminal 30 encrypts a propagation permission request message, together with its own signature, using the public key of the inviter terminal 20, which was received at step S202, and then sends the resulting propagation permission request message (step S301).

The inviter terminal 20 decrypts the propagation permission request message using its own private key, and determines whether the invitee terminal 30 that sent the propagation permission request message corresponds to the invitee party invited by the inviter terminal 20 (step S302).

When the determination about the invitee terminal 30 is completed, the inviter terminal 20 adds the information of the invitee terminal 30 to a message-propagation-permission list, and sends a propagation permission response message to the invitee terminal 30 at step S303.

When the security group 10 is created over the P2P network, as described above, secure communication and service can be provided between desired peers, that is, between the inviter terminal 20 and the invitee terminals 30.

While the invention has been shown and described with respect to the preferred embodiment, it will be understood by those skilled in the art that various changes and modifications may be made without departing from the spirit and scope of the invention as defined in the following claims.

What is claimed is:

1. A method of creating a security group over a Peer-To-Peer (P2P) network, comprising:
one or more invitee terminals each attaching a public key to a peer advertisement in which its own identification information is encrypted using its own private key, and sending a resulting peer advertisement over the P2P network;
an inviter terminal, which has found the peer advertisement, encrypting a group advertisement, including group information about the security group, using public keys of the corresponding invitee terminals, and then sending resulting group advertisements to the invitee terminals which the inviter terminal desires to invite to the security group; and
each of the invitee terminals which received the group advertisements decrypting the received group advertisement using its own private key, and participating in the security group using the group information.

2. The method of claim 1, wherein each of the group advertisements comprises a public key and a signature of the inviter terminal.

3. A method of an inviter terminal of a security group authenticating one or more invitee terminals over a P2P network, comprising:
the invitee terminals each encrypting a propagation permission request message, together with its own signature, using a public key of the inviter terminal, and sending a resulting propagation permission request message, so as to propagate a message within the security group;
the inviter terminal decrypting the propagation permission request message using its own private key, and then authenticating whether the invitee terminal corresponds to a terminal that the inviter terminal has invited; and
when the authentication is completed, the inviter terminal sending a propagation permission response message to the corresponding invitee terminal.

4. The method of claim 3, wherein the public key is included in a group advertisement, including group information about the security group, and sent when the inviter terminal invites the invitee terminal to the security group.

5. A device for creating a security group over a P2P network, comprising:
one or more invitee terminals each for attaching a public key to a peer advertisement, in which its own identification information is encrypted using its own private key, sending a resulting peer advertisement over the P2P network, and, when a group advertisement including group information about the security group is sent over the P2P network, decrypting the group advertisement using its own private key and participating in the security group using the group information; and
an inviter terminal for searching for the peer advertisement to be sent over the P2P network, encrypting the group advertisement using respective public keys of the corresponding invitee terminals, and sending resulting group advertisements to the invitee terminals which the inviter terminal desires to invite to the security group.

6. The device of claim 5, wherein each of the group advertisements comprises a public key and a signature of the inviter terminal.

7. A device for authenticating participation in a security group over a P2P network to which a group advertisement, including group information about the security group and a public key of an inviter party, is sent, the device comprising:
one or more invitee terminals each for encrypting a propagation permission request message, together with its own signature, using the public key, and sending a resulting propagation permission request message so as to propagate a message within the security group; and
an inviter terminal for decrypting the propagation permission request message using its own private key, authenticating whether the invitee terminal corresponds to a terminal invited by the inviter terminal, and, when the authentication is completed, sending a propagation permission response message to the corresponding invitee terminal.

8. The device of claim 7, wherein the public key is included in a group advertisement and sent when the inviter terminal invites the invitee terminal to the security group.
